(19) United States
(12) Patent Application Publication
(10) Pub. No.: US 2004/0143199 A1
(43) Pub. Date: Jul. 22, 2004

(54) Orthopedic heating pad (OHP) orthopedic vibrating heating pad (OVHP)

(76) Inventors: Georgia Cotterell-Grant, Lauderdale Lakes, FL (US); Garfield Grant, Lauderdale Lakes, FL (US)

Correspondence Address: GEORGIA COTTERELL-GRANT, 3520 NW 50th AVENUE P108, LAUDERDALE LAKES, FL, 33319, US

(21) Appl. No.: 10/188,410

(22) Filed: Jan. 21, 2003

(51) Int. Cl. A61H 23/02

(52) U.S. Cl. 601/15; 601/70

(57) ABSTRACT

I, Georgia Cotterell Grant, have created an invention consisting of an electrical heating device suitable to be used in the medical treatment of joint sprains, strains, arthritis, and muscular pains.

My invention will provide electrical heat in conjunction with a vibratory sensation through a pad made of cloth, in which is inserted a heated element, and a vibratory device. The pad is plugged into an electrical outlet, and contributes directly to the healing of the relevant affected body parts. Through the use of a switch that is attached to the pad by an electrical cord the user regulates the temperature and vibratory force.

This invention is superior to other heating devices which depend on indirect heat such as hot water and a microwave oven to be effective, and which do not have a vibratory/massaging effect.

### BACKGROUND OF THE INVENTION

This invention pertains to the medical field. It was created as a manipulative treatment against disorders of the skeletal system, particularly those joints at which the skeleton is joined. This includes the knees, ankles, elbows, wrists and shoulders.

The foot and ankle is a common source of disability. It consists of the tibia or leg bone, fibula (smaller of the two leg bones), the ankle-bone (talus), and a complicated articulation between them and many bones below. Its joints allow motion on many planes. Ankle problems are widespread and range from damage of the cartilage in the joint to damage to the bones. An ankle sprain is the most common injury.

Knee problems include overuse injuries, acute injuries, arthritis, metabolic processes (diabetes or lupus), and inflammation such as infection. The most common presentation to the doctor is a knee that hurts or one that feels insecure doing certain activities.

I have invented this product so as to provide consumers with a more pain free and normal life. I broke my ankle in 1993 while playing the sport of Netball and as Murphy's Law would have it, injured my knee in a traffic accident three months later. I strongly believe that had this product been available on the market, my healing process would have progressed much faster and life would have been more comfortable.

Although not utilizing any formal reference material, sufficient information was garnered from scrutinizing existing products on the market. This scrutiny brought to light that there were deficiencies in human joint treatment equipment. My research indicated that there was the need for a gadget that supplies continuous heat and a vibratory impact on the affected area of the body. Most products have gel, stones, sand or some other component that requires some degree of indirect heating so as to be effective.

This invention will provide both heat and a vibratory reaction through the direct source of electrical energy. This will have a more significant and durable impact on the injured area, resulting in faster healing.

### BRIEF SUMMARY OF THE INVENTION

My invention, the ORTHOPEDIC VIBRATING/HEATING PAD, is designed for the knee and ankle and other skeletal joints. Its external component is made from a sturdy cloth material with a heating element existing on the inside of the pad. This comfortable gadget is secured to the affected joint by two Velcro straps. A hand held electrical switch that is attached to the pad by an electrical cord controls the heating and vibratory function of the pad.

This invention is multi-purpose. It is designed to apply continuous warmth, moisture, a mild compression and a soothing vibratory sensation to the affected area, while relieving pain and stiffness. The consumer will have the freedom of choice for selecting heat, vibration or both. The availability of heat is made possible by simply inserting the attached cord into an electrical outlet, that is, a socket. This presents a significant improvement over existing gadgets, which are not self-sufficient.

For best results, this product should be applied to the affected area for fifteen (15) to twenty (20) minutes periods

This invention is being introduced into the market with the definite objective of offering consumers a more effective means of healing joint and muscular injuries and/or disorders.

### BRIEF DESCRIPTION OF THE SEVERAL VIEWS OF THE DRAWING

FIG. 1

This figure illustrates the following:

Loop Fasteners and Velcro Straps—secures the heating pad on the affected area. The straps are inserted through the loops and held in place by the Velcro adhesive.

Element—area in which heat is concentrated.

Insulated Pad—ensures that heat is maintained within and distributed throughout the Heating Pad.

Hand Held Switch—allows the user to control the application of the treatment.

Power Cord—Transmits electricity to the invention for the availability of heat.

FIG. 2

This figure illustrates the actual placement of the invention on the ankle and surrounding areas. This figure further illustrates the comfort level of the invention as its compact design assimilates with the actual shape of the ankle and its surrounding areas. The Velcro straps have been placed through the loops and secured with the adhesive.

FIG. 3

This figure illustrates a rear view of the fitted product before the Velcro straps have been secured through the loops.

FIGS. 4a & 4b

Both figures illustrate a two-dimensional view of the invention fitted on the knee and its surrounding areas.

FIG. 5

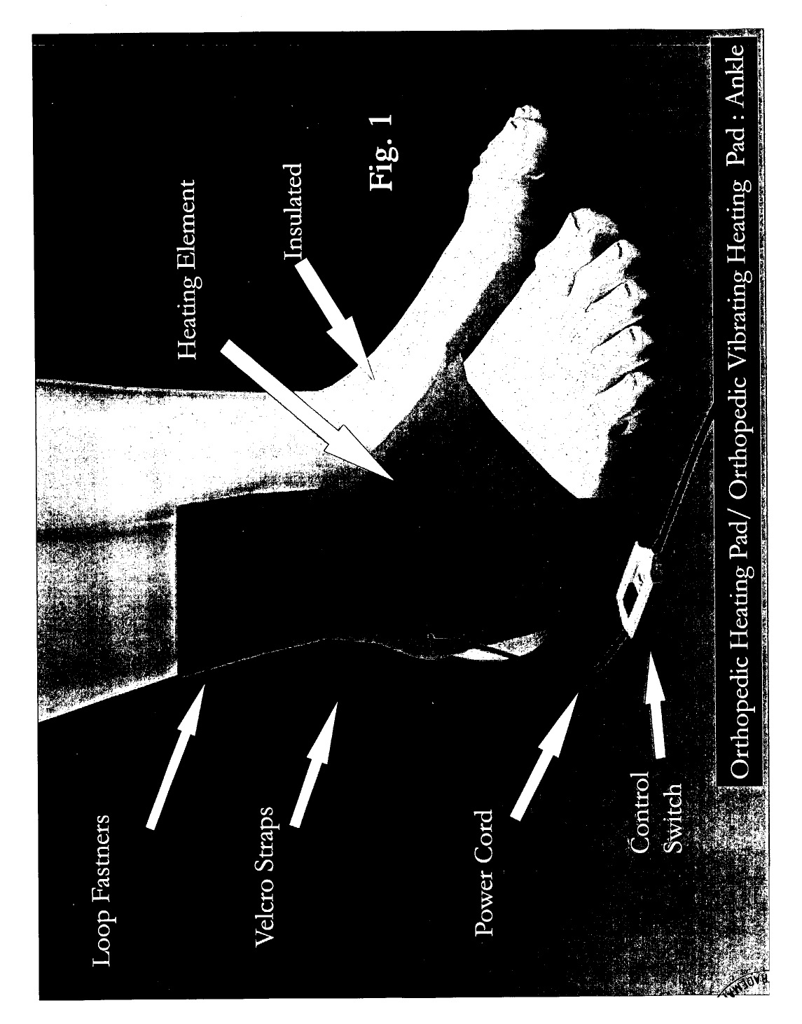

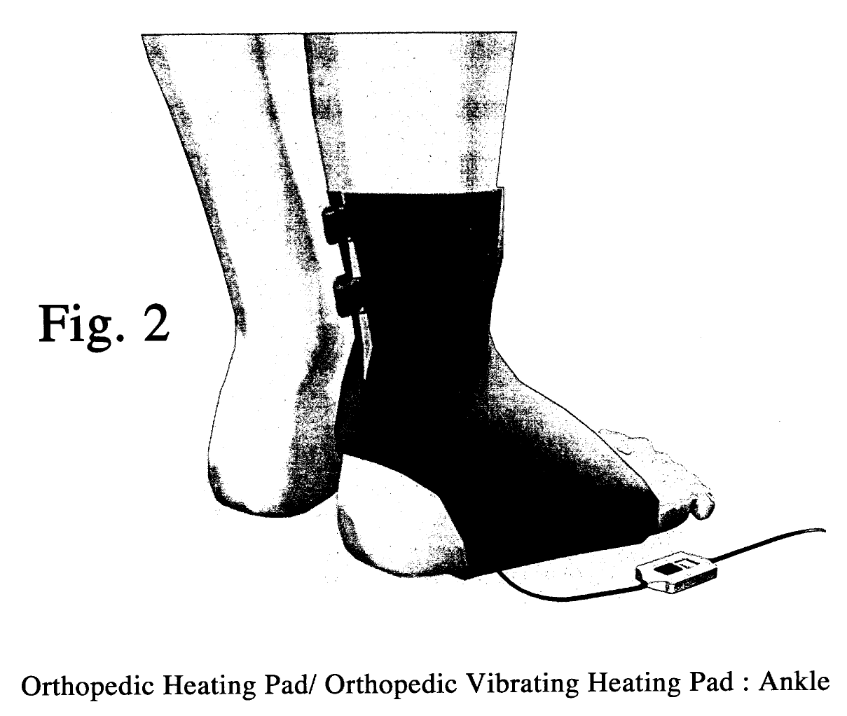

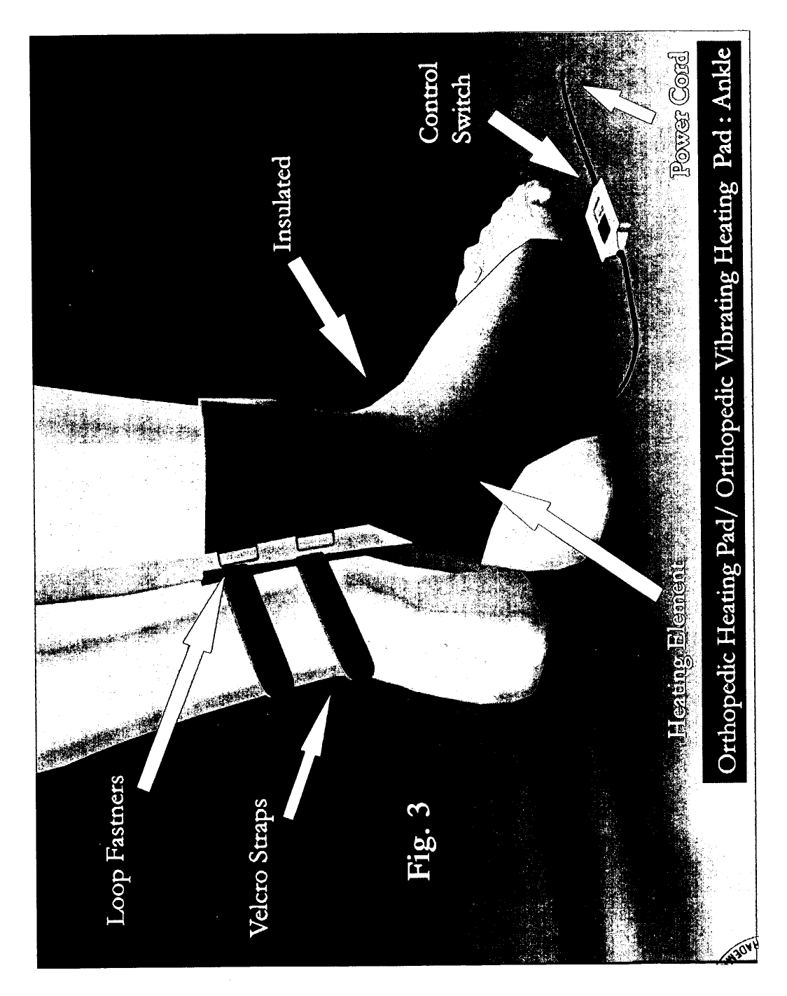

This figure illustrates a three-dimensional view of FIGS. 1&2.

### DETAILED DESCRIPTION OF THE INVENTION

The objective in creating this invention is to create a gadget that will provide heat and vibration stimuli to injured or damaged joint areas, particularly the knee and ankles, resulting in a faster healing process.

With this objective in mind this invention was designed to be comfortable while simultaneously effectively aiding the healing process.

This invention is basically a simple structure. The pad component is made from a sturdy cloth-like fabric; flexible enough to snuggly fit the knee, ankle or other relevant joint. Affixed to this pad are two (2) Velcro straps and two (2) loop fasteners, the purpose of which is to stabilize the pad to the affected joint.

A heating element is located inside of the pad, sufficiently insulated by relevant material to protect the user of the pad from the adverse effects (burns, abrasions of the skin) created by misuse of the electrical heat generated from the elements.

Attached to the heating element is an electrical cord (approximately two (2) feet in length) that runs through the pad to a switch apparatus (that is designed to be hand-held). This power switch serves to control the ‘on and off’ of electricity, regulate temperature and the vibratory force that emits from the pad to the affected area. Another length of extension cord (approximately three (3) feet in length), with a three-prong plug at the end runs from the switch to be inserted into an electrical socket.

Unlike other heat healing gadgets that were invented to heal skeletal joint disorders, this invention provides direct, regulated heat and vibration to the affected area on a consistent basis. Most other heating pads do not use electrical energy, and as a result the heat generated fluctuates, tending to cool too rapidly. The user of these pads either has to hobble around, or get assistance, to get the pad reheated in hot water, or in a microwave oven.

Moreover, existing inventions do not provide a simultaneous vibratory effect that serves to gently massage the affected joint, as this invention does. This massage effect provides a soothing sensation to the affected area, and directly assists in the healing process.

The invention will be developed into different types, suitable to be fitted unto specific joint areas. For example, there will be a specific pad for the knee and another for the ankle. Thus, the consumer will be offered the option of acquiring the type of pad that is more suitable for his/her particular ailment.

The pad is fitted around the relevant joint, affixed firmly, but comfortably by the Velcro straps. The user will sit or lie in close proximity to an electrical outlet, plug in the electrical cord, direct the switch to ‘on’, and begin the heat generating and vibrating process. The user will hold the switch in his/her hand and regulate the heat and vibrating force as necessary.

To be more effective, the pad should be switched on for periods of 15-20 minutes.

1. I claim originality for my invention, the ORTHOPEDIC VIBRATING/HEATING PAD. The product is an original as it combines both elements of heat and a vibratory sensation.
This claim is possible as extensive research was carried out, which provided information supporting the non-existence of any other product of this nature and design:
I further claim that my invention is the only invention which through its spontaneous, durable, adjustable and effective heating and vibratory functions will provide a faster healing process to persons with joint sprains, strains, fractures, arthritis, sore muscles, aching and/or swelling of the knees, ankles or other joints.
